(19) United States
(12) Patent Application Publication
(10) Pub. No.: US 2015/0369209 A1
(43) Pub. Date: Dec. 24, 2015

(54) ROTOR BLADE TRANSPORTATION SYSTEM

(71) Applicant: General Electric Company, Schenectady, NY (US)

(72) Inventors: Madireddi Vasu Datta, Bangalore (IN); Stephen Bertram Johnson, Greenville, SC (US); Juliana Cristina Balzanini de Macedo Vieira, Sao Paulo (BR)

(73) Assignee: General Electric Company

(21) Appl. No.: 14/312,602

(22) Filed: Jun. 23, 2014

(51) Int. Cl. F03D 1/00; B60P 3/40

(52) U.S. Cl. CPC F03D 1/005; B60P 3/40

(57) ABSTRACT

A transportation system for transporting rotor blades includes a rotor blade fixture configured to support one or more rotor blades. The rotor blade fixture has a first end, and a second end opposed to the first end. The first end is configured for mounting to a root end of a first rotor blade. The rotor blade fixture has a mid-span support located between about 50% and about 80% of a rotor blade span of the first rotor blade. The mid-span support is configured for supporting a mid-span portion of the rotor blade. The rotor blade fixture is configured to mount to a supporting surface so that a portion of the rotor blade fixture and the first rotor blade overhangs the supporting surface. The one or more rotor blades are supported at the root end and at a mid-span location located between about 50% and 80% of the rotor blade span.

### FIELD OF THE INVENTION

The present disclosure relates in general to wind turbine rotor blades, and more particularly to systems for transporting rotor blades.

### BACKGROUND OF THE INVENTION

Wind power is considered one of the cleanest, most environmentally friendly energy sources presently available, and wind turbines have gained increased attention in this regard. A modern wind turbine typically includes a tower, generator, gearbox, nacelle, and one or more rotor blades. The rotor blades capture kinetic energy of the wind using known foil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

The size, shape, and weight of rotor blades are factors that contribute to energy efficiencies of wind turbines. An increase in rotor blade size increases the energy production of a wind turbine, while a decrease in weight also furthers the efficiency of a wind turbine. Presently, large commercial wind turbines in existence and in development are capable of generating from about 1.5 to about 12.5 megawatts of power. These larger wind turbines may have rotor blade assemblies larger than 90 meters in diameter. Accordingly, efforts to increase rotor blade size, decrease rotor blade weight, and increase rotor blade strength, while also improving rotor blade aerodynamics, aid in the continuing growth of wind turbine technology and the adoption of wind energy as an alternative energy source.

As the size of wind turbines increase, and particularly the size of rotor blades, so do the respective costs of manufacturing, transporting, and assembling the wind turbines. The economic benefits of increased wind turbine sizes must be weighed against these factors. For example, the costs of pre-forming, transporting, and erecting a wind turbine having rotor blades in the range of 90 meters or more may significantly impact the economic advantage of the larger wind turbine.

For example, the costs of transporting rotor blades increase as the size of the rotor blades increase. One known method for transporting rotor blades involves the use of large trucks, such as tractor-trailers. The rotor blades are loaded onto trailers, which are hauled by the trucks to a desired destination. Frequently, however, this transportation method is hindered by the existence of obstacles that restrict such transportation. Many roads pass by walls, bridges, hills, mountains, trees or other such obstacles that are situated relatively close to the road, or over the road. Rotor blades having increasing lengths may overhang the trucks on which they are being transported. Unsupported overhanging portions of the rotor blade may flex and undesirably contact obstacles during transport. If a truck is required to turn in a location wherein such obstacles are close to the road, the rotor blades may be at further risk of contacting the obstacles, resulting in damage to the rotor blades.

Known solutions to these transportation problems require, for example, removing the rotor blade from the truck while the truck is turning. These solutions can be expensive and time-consuming For example, traffic on the road must be halted, and a crane or other lifting machinery must be utilized to lift the rotor blade from the truck. The truck must then be allowed to turn on the road. The rotor blade must then be replaced and secured on the truck. An alternative solution involves loading the rotor blades into, for example, boats or barges, or trains, rather than trucks, and transporting the rotor blades along waterways or railroads to a desired destination. This solution, however, is also expensive and time-consuming, and frequently the desired destination of a rotor blade does not have waterways or railroads leading to it. A further alternative solution involves separating the rotor blades into smaller separate rotor blade components for transport. However, separating a rotor blade may weaken the fibers and/or other reinforcing structures within the rotor blade, thus undesirably weakening the rotor blade. Shipping and transporting one rotor blade at a time is also expensive and time consuming.

Accordingly, improved systems for transporting rotor blades are desired in the art. In particular, transportation systems that are relatively efficient, fast, and cost-effective would be desired.

### BRIEF DESCRIPTION OF THE INVENTION

Aspects and advantages of the invention will be set forth in part in the following description, or may be obvious from the description, or may be learned through practice of the invention.

According to one aspect of the invention, a transportation system for transporting one or more rotor blades includes a rotor blade fixture configured to support one or more rotor blades. The rotor blade fixture has a first end and a second end opposed to the first end. The first end is configured for mounting to a root end of a first rotor blade. The rotor blade fixture has at least one first mid-span support located between about 50% and about 80% of a rotor blade span of the first rotor blade. The first mid-span support is configured for supporting a mid-span portion of the first rotor blade. The rotor blade fixture is configured to mount to a supporting surface so that a portion of the rotor blade fixture and the first rotor blade overhangs the supporting surface. The rotor blade fixture includes a truss framework configured to support the one or more rotor blades in the portion that overhangs the supporting surface. The one or more rotor blades are supported at the root end and at a mid-span location located between about 50% and about 80% of the rotor blade span.

According to another aspect of the invention, a transportation system for transporting one or more rotor blades includes a rotor blade fixture configured to support two rotor blades. The rotor blade fixture has a first end and a second end opposed to the first end. The first end is configured for mounting to a root end of a first rotor blade, and the second end is configured for mounting to a root end of a second rotor blade. The rotor blade fixture has at least one first mid-span support configured for supporting a mid-span portion of each of the two rotor blades. The rotor blade fixture is configured to mount to a supporting surface so that a portion of the rotor blade fixture and the two rotor blades overhang the supporting surface. The rotor blade fixture comprises a truss framework configured to support the two rotor blades in the portion that overhangs the supporting surface. The truss framework extends from the root end to at least the mid-span portion

According to yet another aspect of the invention, a transportation system for transporting one or more rotor blades includes a rotor blade fixture configured to support two rotor blades. The rotor blade fixture includes a first root mounting fixture for mounting to a root end of a first rotor blade, and a second root mounting fixture for mounting to a root end of a second rotor blade. The first root mounting fixture is separated from the second root mounting fixture in a span direction of the two rotor blades. The rotor blade fixture is configured to mount to a supporting surface, and a portion of the rotor blade fixture overhangs the supporting surface. The rotor blade fixture includes a truss framework configured to support at least one of the two rotor blades in the portion that overhangs the supporting surface. The root end of the second rotor blade is located substantially forward, in the span direction, of the root end of the first rotor blade. The supporting surface may be a trailer, and the rotor blade fixture is configured so that a center of gravity of the fixture and the two rotor blades is located above a portion of the trailer.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine.

FIG. 2 illustrates a side view of a single rotor blade configured for road transport.

FIG. 3 illustrates a perspective view of the root fixture used in FIG. 2.

FIG. 4 illustrates an end view of a rotor blade attached to the root fixture of FIG. 3.

FIG. 5 illustrates a perspective view of the tip fixture used in FIG. 2.

FIG. 6 illustrates a perspective view of a rotor blade fixture for transporting one or more rotor blades, according to an aspect of the present invention.

FIG. 7 illustrates a side view of the rotor blade fixture of FIG. 6, according to an aspect of the present invention.

FIG. 8 illustrates a perspective view of a rotor blade fixture for transporting one or more rotor blades, according to an aspect of the present invention.

FIG. 9 illustrates a side view of the rotor blade fixture of FIG. 8, according to an aspect of the present invention.

FIG. 10 illustrates a perspective view of a rotor blade fixture for transporting one or more rotor blades, according to an aspect of the present invention.

FIG. 11 illustrates a side view of the rotor blade fixture of FIG. 10, according to an aspect of the present invention.

FIG. 12 illustrates a perspective view of a rotor blade fixture for transporting one or more rotor blades, according to an aspect of the present invention.

FIG. 13 illustrates a side view of the rotor blade fixture 1200 of FIG. 12, according to an aspect of the present invention.

FIG. 14 illustrates a perspective view of a rotor blade fixture for transporting one or more rotor blades, according to an aspect of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

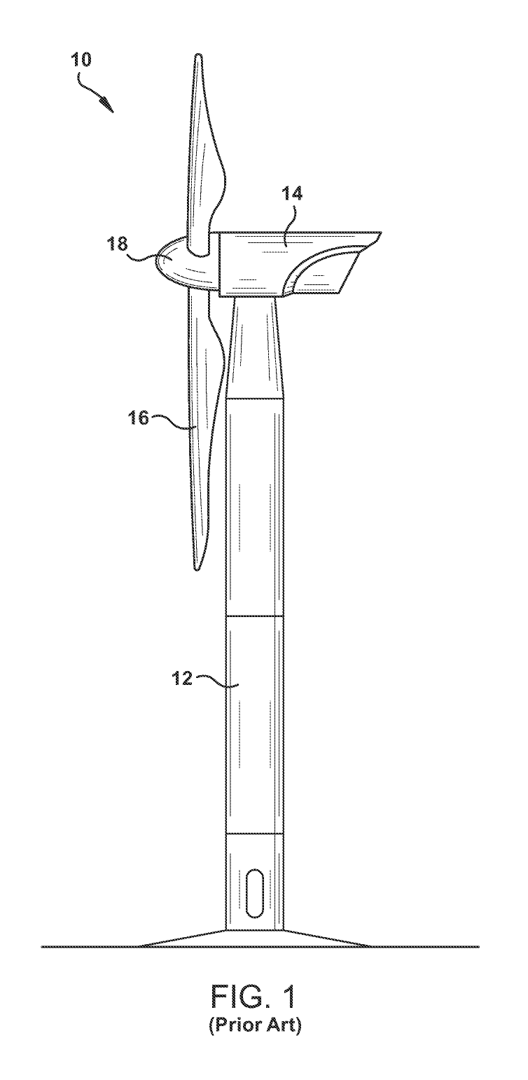

FIG. 1 illustrates a wind turbine 10 of conventional construction. The wind turbine 10 includes a tower 12 with a nacelle 14 mounted thereon. A plurality of rotor blades 16 are mounted to a rotor hub 18, which is in turn connected to a main flange that turns a main rotor shaft. The wind turbine power generation and control components are housed within the nacelle 14. The view of FIG. 1 is provided for illustrative purposes only to place the present invention in an exemplary field of use. It should be appreciated that the invention is not limited to any particular type of wind turbine configuration.

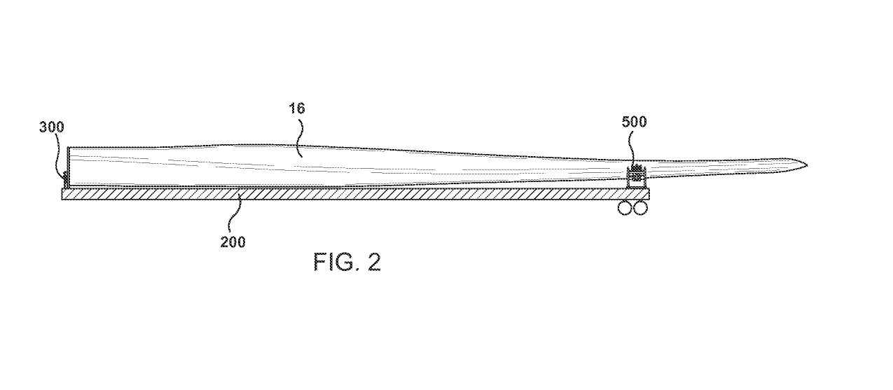

FIG. 2 illustrates a side view of a single rotor blade configured for road transport. The rotor blade 16 is mounted on a trailer 200, which may be towed by a suitable truck or other motorized vehicle. The rotor blade 16 is secured at the root end with a root fixture 300 (which may also be referred to as a root stand). The root fixture is secured to the trailer 200 by any suitable means, for example, chains, bolts, welding, etc. A tip fixture 500 is used for securing a mid-span portion of the rotor blade 16. The tip fixture is also secured to the trailer 200 by any suitable means, for example, chains, bolts, welding, etc.

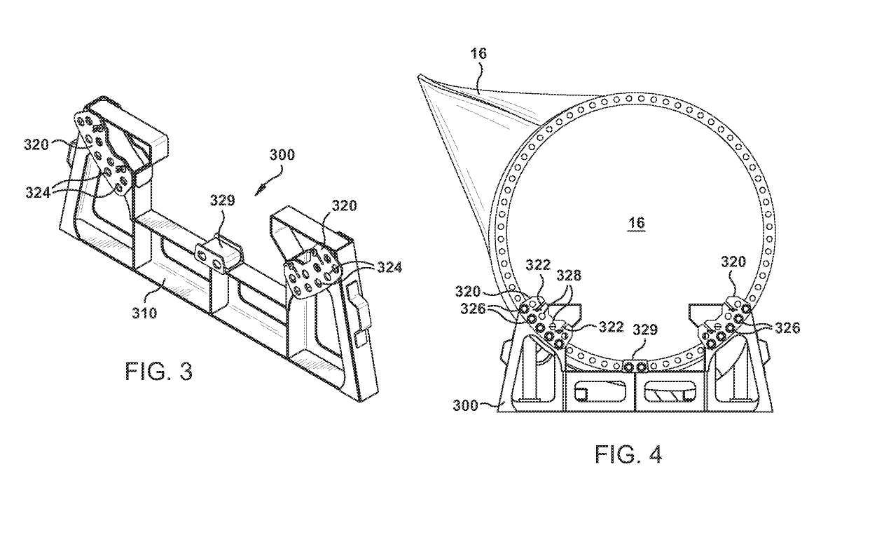

FIG. 3 illustrates a perspective view of the root fixture 300. The root fixture 300 includes a main body or frame 310. Two mounting plates 320 are mounted on the frame 310 and configured to be adjustable in the radial direction, with respect to the blade root. Two slots 322 are provided and permit the mounting plates 320 to be moved radially inward or radially outward, to adjust for different sized rotor blades. For example, a longer rotor blade may have a larger root diameter, so the plates will have to be slid radially outward (or generally down in the Figure). A plurality of fasteners can be used to lock the mounting plates in their desired position. The mounting plates 320 also include a plurality of bolt holes 324, arcuately arranged, configured to cooperate with the root bolts on rotor blade 16. In the example shown, each mounting plate 320 includes five bolt holes 324 and each of these will accept a root bolt on rotor blade 16. The root bolts can be secured to the mounting plates 320 by the use of nuts 326. The mounting plates 320 may also include an additional set of bolt holes 328 configured for rotor blades having a smaller root diameter. The moveable plates 320 may also be configured to handle a rotor blade with a different numbers of bolts. For example, the root bolts are on the same bolt circle (i.e., same radius), but there are different number of root bolts or they may have a different spacing. A bottom mounting bracket 329 is located to align with the bottom of the blade root and the bottom two root mounting bolts. Fasteners, such as nuts, can be used to secure the bottom two root mounting bolts to the bottom mounting bracket 329.

FIG. 4 illustrates an end view of a rotor blade 16 attached to the root fixture 300. In the example of FIG. 4, ten rotor blade root bolts are fastened to the root fixture 300, and in most cases this will be sufficient for road or rail transport. However, it is to be understood that more or less root bolts may be fastened to the root fixture, as desired in the specific application and transport route.

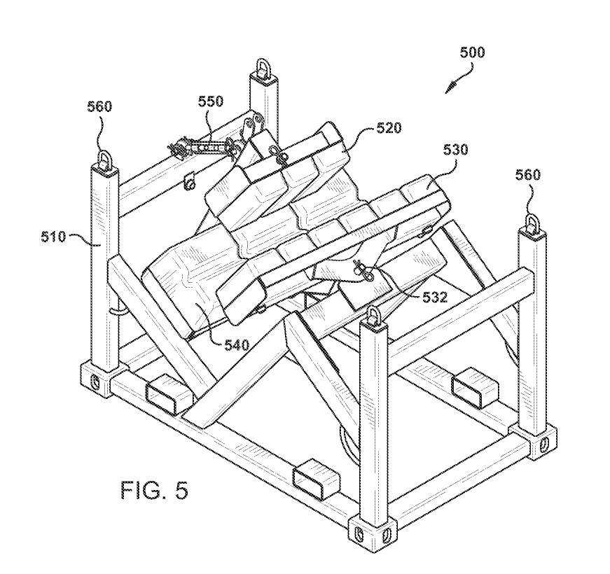

FIG. 5 illustrates a perspective view of the tip fixture 500. The tip fixture 500 includes a main frame 510 that supports side cushions 520, 530 and an edge cushion 540. The edge cushion 540 may be configured to cushion the leading edge of blade 16. The side cushion 530 is generally fixed in position but can pivot on a pin 532. The cushion 520 can be clamped against the blade 16 by operation of turnbuckle 550. For example, as turnbuckle 550 is lengthened the cushion 520 is driven toward blade 16 (not shown) until the desired force is applied. A plurality of lifting rings 560 may also be attached to frame 510 to facilitate lifting of tip fixture 500 as well as blade 16.

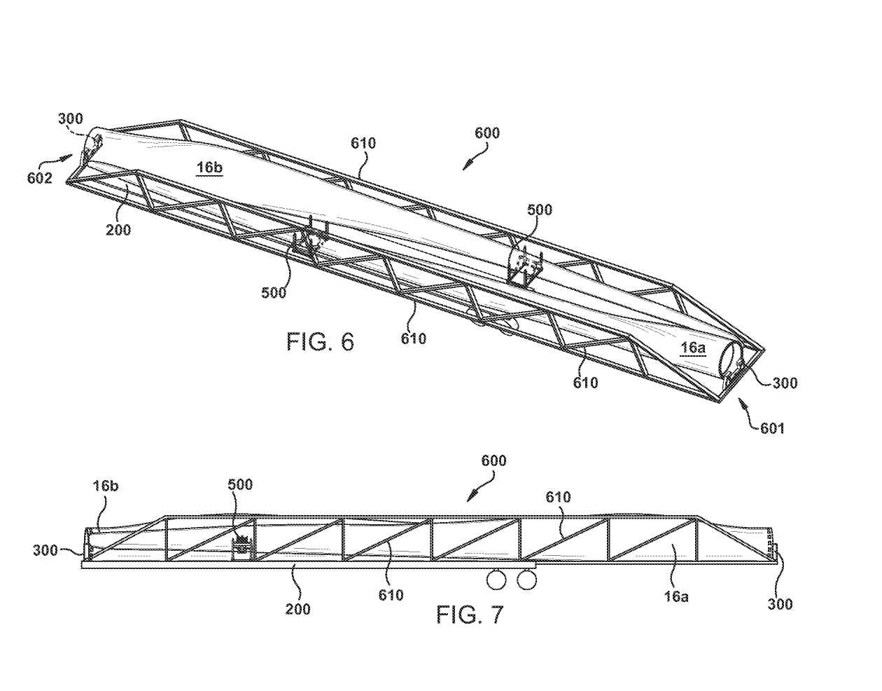

FIG. 6 illustrates a perspective view of a rotor blade fixture 600 for transporting one or more rotor blades 16, according to an aspect of the present invention. The rotor blade fixture 600 is configured to support the rotor blades 16a, 16b through the root fixture 300 and tip fixture 500, both of which may be secured to the trailer 200 and/or frame (or framework) 610 of root blade fixture 600. The rotor blade fixture 600 has a first end 601 and a second end 602 opposed to the first end. The first end 601 is configured for mounting to a root end of the first rotor blade 16a (via root fixture 300). The rotor blade fixture 600 has at least one first mid-span support 500 (i.e., the tip fixture), which may be located between about 50% and about 80% of the rotor blade span (or length) of the first rotor blade 16a. The first mid-span support or tip fixture 300 is configured for supporting a mid-span portion of the first rotor blade 16a. The rotor blade fixture 600 is configured to mount to a supporting surface (e.g., trailer 200) so that a portion of the rotor blade fixture 600 and the first rotor blade 16a overhangs the supporting surface. The rotor blade fixture 600 may be configured so that a center of gravity of the fixture 600 and the one or more rotor blades 16a, 16b is located above a portion of the trailer 200. In the example shown, the center of gravity would be just in front of the rear trailer wheels, and about a third of the rotor blade fixture 600 overhangs from trailer 200. The rotor blades 16a, 16b are supported at the root end of each blade and at a mid-span location of each blade, and the mid-span location may be located between about 50% and about 80% of the rotor blade span (or rotor blade length). The rotor blade may be designed to include additional internal support structure in the desired mid-span mounting area. As one example only, at a mid-span location about 60% of the rotor blade span from the root end, the blade 16 may be reinforced to accommodate the tip fixture 500. However, it is to be understood that the tip fixture 500 can be placed at any suitable location on blade 16, as desired in the specific application.

The second end 602 is configured for mounting to a root end of the second rotor blade 16b. The rotor blade fixture 600 has at least one second mid-span support 500 located between about 50% and about 80% of a rotor blade span (rotor blade length) of the second rotor blade 16b. The second mid-span support 500 is configured for supporting a mid-span portion of the second rotor blade 16b. The rotor blade fixture 600 includes two substantially parallel truss walls. The truss walls add rigidity and strength to the fixture 600 and may support the overhanging portions of the rotor blades 16a, 16b. The truss walls may be formed of steel or aluminum (or any other suitable material) and the individual truss elements may be welded or bolted together. As shown, the rotor blades are configured to be retained between the two truss walls.

FIG. 7 illustrates a side view of the rotor blade fixture 600 of FIG. 6. In this one example, about a third of the rotor blade fixture 600 and blades 16a, 16b overhang off the back of trailer 200. The center of gravity of the fixture 600 and the rotor blades 16a, 16b is located above trailer 200 and in front of the trailer's rear wheels. Each rotor blade 16a, 16b is alternately arranged so one root is placed at each end of rotor blade fixture 600. Accordingly, one root fixture 300 is also located at each end of the rotor blade fixture. The mid-span support (or tip fixture) 500 may be located about 50% to about 80% of the rotor blade span (i.e., length) as measured from the root end. For example, for a 200 foot long rotor blade, the mid-span support may be located about 100 feet to about 160 feet from the root end. However, one or more mid-span supports could be located in any suitable location along blade 16, as desired in the specific application.

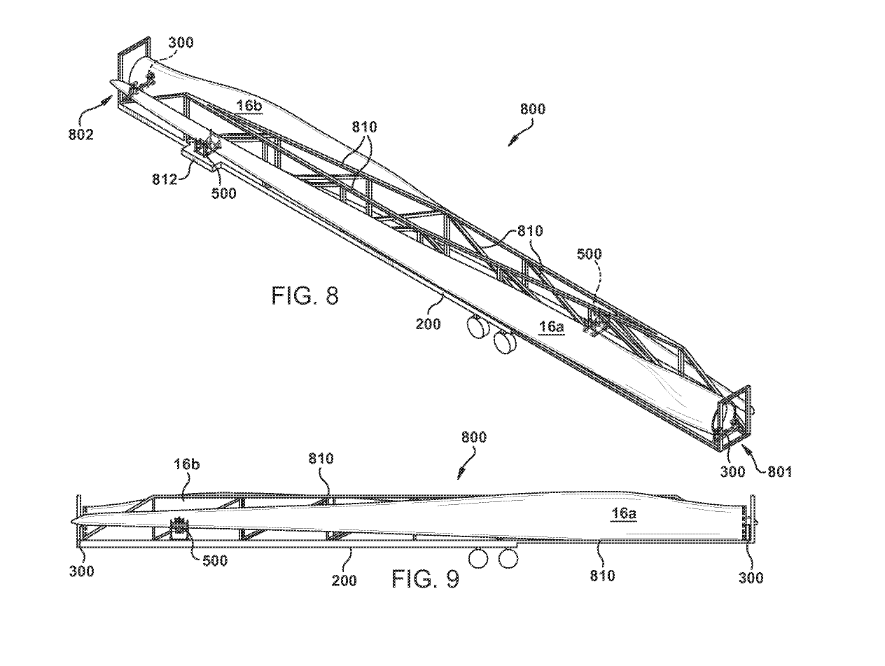

FIG. 8 illustrates a perspective view of a rotor blade fixture 800 for transporting one or more rotor blades 16a, 16b, according to an aspect of the present invention. The rotor blade fixture 800 is configured to support and be located substantially between the two rotor blades 16a, 16b. The root fixture 300 and tip fixture 500 may be secured to the trailer 200 and/or frame (or framework) 810 of root blade fixture 800. The rotor blade fixture 800 has a first end 801 and a second end 802 opposed to the first end. The first end 801 is configured for mounting to a root end of the first rotor blade 16a (via root fixture 300), and the second end 802 is configured for mounting to a root end of the second rotor blade 16b. The rotor blade fixture 800 has at least one first mid-span support 500 (i.e., the tip fixture). The mid-span support or tip fixture 300 is configured for supporting a mid-span portion of the rotor blade. In this example, a platform 812 is provided for each rotor blade, and the platform 812 may be used for mounting tip fixture (or mid-span support) 500 to the frame 810. The platform is configured for supporting and securing a mid-span support 500 (or tip fixture). For example, the platform 812 may be welded to the rotor blade fixture 800 or attached to the trailer surface. The platform may extend outside the width of the supporting surface or trailer 200. The rotor blade fixture 800 is configured to mount to a supporting surface (e.g., trailer 200) so that a portion of the rotor blade fixture 800 and the rotor blades 16a, 16b overhang from the supporting surface. The rotor blade fixture 800 is configured so that a center of gravity of the fixture 800 and the one or more rotor blades 16a, 16b is located above a portion of the trailer 200. In the example shown, the center of gravity would be in front of the rear trailer wheels. The rotor blade fixture 800 includes two truss walls. The truss walls add rigidity and strength to the fixture 800 and may support the overhanging portions of the rotor blades 16a, 16b. The truss walls may be formed of steel or aluminum (or any other suitable material) and the individual truss elements may be welded or bolted together. As shown, the truss walls are configured to be located between the two rotor blades.

FIG. 9 illustrates a side view of the rotor blade fixture 800 of FIG. 8. In this one example, about a third of the rotor blade fixture 800 and blades 16a, 16b overhang off the back of trailer 200. Each rotor blade 16a, 16b is alternately arranged so one root is placed at each end of rotor blade fixture 800. The mid-span support (or tip fixture) 500 may be located about 50% to about 80% of the rotor blade span (i.e., length) as measured from the root end. However, one or more mid-span supports could be located in any suitable location along blade 16a, 16b and multiple platforms 812 may also be provided, as desired in the specific application. The rotor blade fixture 800 reduces total weight, by having shorter support trusses focused between the rotor blades.

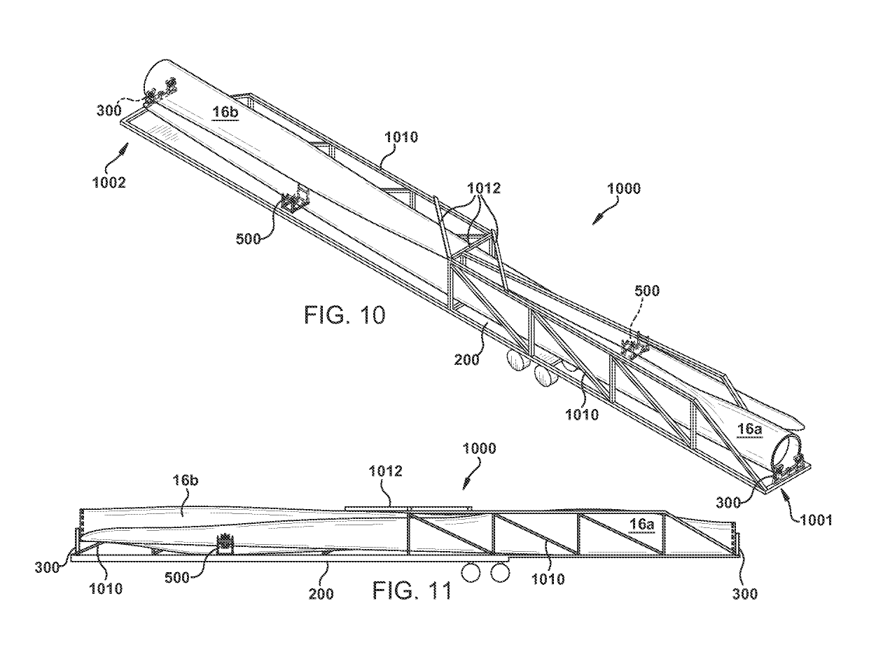

FIG. 10 illustrates a perspective view of a rotor blade fixture 1000 for transporting one or more rotor blades 16a, 16b, according to an aspect of the present invention. The rotor blade fixture 600 is configured to support, and be located substantially on a leading edge side and a trailing edge side of, the two rotor blades 16a, 16b. The root fixture 300 and tip fixture 500 may be secured to the trailer 200 and/or frame (or framework) 1010 of root blade fixture 1000. The rotor blade fixture 1000 has a first end 1001 and a second end 1002 opposed to the first end. The first end 1001 is configured for mounting to a root end of the first rotor blade 16a (via root fixture 300), and the second end 1002 is configured for mounting to a root end of the second rotor blade 16b. The rotor blade fixture 1000 has at least one first mid-span support 500 (i.e., the tip fixture). The mid-span support or tip fixture 300 is configured for supporting a mid-span portion of the rotor blade. The rotor blade fixture 1000 is configured to mount to a supporting surface (e.g., trailer 200) so that a portion of the rotor blade fixture 1000 and the rotor blades 16a, 16b overhang from the supporting surface. The rotor blade fixture 1000 is configured so that a center of gravity of the fixture 1000 and the one or more rotor blades 16a, 16b is located above a portion of the trailer 200. In the example shown, the center of gravity would be in front of the rear trailer wheels. The rotor blade fixture 1000 includes two truss walls. The truss walls add rigidity and strength to the fixture 1000 and may support the overhanging portions of the rotor blades 16a, 16b. A removable top section 1012 is configured to facilitate loading and unloading of the rotor blades 16a, 16b. For example, the top section 1012 members (three are shown) may be removed (e.g., un-bolted) so that the rotor blades may be placed on trailer 200 and in rotor blade fixture 1000. The top section members can be replaced (bolted back on) after the blades are set in place. The top section 1012 members add rigidity and strength to the frame 1010. The rotor blade fixture may be configured to have a width equal to or less than a width of the trailer 200. The truss framework 1010 may be configured to extend from the root end to at least the mid-span portion of the rotor blades. For example, with blade 16a, the truss framework extends mainly from the root end to a mid- portion of blade 16a.

FIG. 11 illustrates a side view of the rotor blade fixture 1000 of FIG. 10. In this one example, about a third of the rotor blade fixture 1000 and blades 16a, 16b overhang off the back of trailer 200. Each rotor blade 16a, 16b is alternately arranged so one root is placed at each end of rotor blade fixture 1000. The rotor blade fixture 1000 reduces total weight, by having most of the support trusses located in the rear half of the rotor blade fixture. This is where most of the support will be required due to the overhanging rotor blade portions.

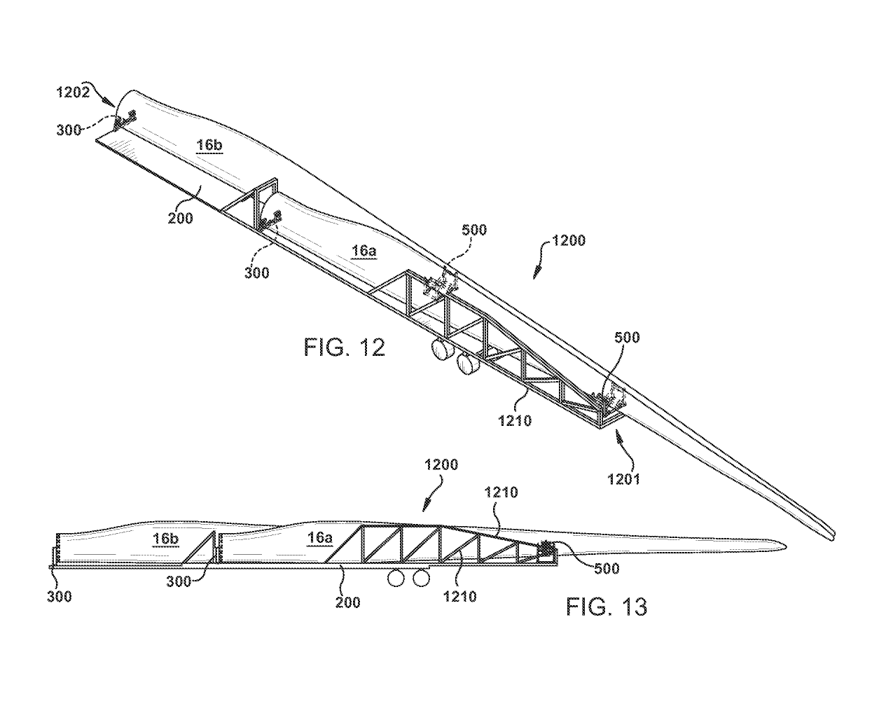

FIG. 12 illustrates a perspective view of a rotor blade fixture 1200 for transporting one or more rotor blades 16a, 16b, according to an aspect of the present invention. The rotor blade fixture 1200 is configured to support two rotor blades 16a, 16b. A first root mounting fixture 300 mounts to a root end of the first rotor blade 16a, and a second root mounting fixture 300 mounts to a root end of a second rotor blade 16b. Both root mounting fixtures 300 may be secured to trailer 200 (e.g., by welding, chaining or any other suitable method). The first root mounting fixture is separated from the second root mounting fixture in a span direction of the two rotor blades. The rotor blade fixture 1200 is configured to mount to a supporting surface (e.g., trailer 200), and a portion of the rotor blade fixture 1200 overhangs the supporting surface. The rotor blade fixture 1200 includes a truss framework 1210 configured to support at least one of the two rotor blades in the portion that overhangs the supporting surface. The root end of the second rotor blade 16b is located substantially forward, in the span direction, of the root end of the first rotor blade 16a. The mid-span supports 500 (i.e., the tip fixtures) may be mounted on the trailer 200 or on the rotor blade fixture 1200. The supporting surface, which may be trailer 200, and the rotor blade fixture 1200 are configured so that a center of gravity of the fixture 1200 and the two rotor blades 16a, 16b is located above a portion of the trailer 200. The advantage of this design is that the overall width of the load may be reduced, even though the overall length is greater. In some transport routes, the width can be a limiting factor, so this configuration may be desirable in those applications. The rotor blades may be viewed as being in a staggered arrangement, wherein the root of rotor blade 16b is located substantially forward of the root end of rotor blade 16a.

FIG. 13 illustrates a side view of the rotor blade fixture 1200 of FIG. 12. In this one example, about a third or more of the rotor blade fixture 1200 and blades 16a, 16b overhang off the back of trailer 200. Each rotor blade 16a, 16b is arranged in a staggered fashion so one root is displaced from the other. The rotor blade fixture 1200 reduces total weight, by having most of the support trusses located in the rear half of the rotor blade fixture, and reduces overall width due to the staggered blade configuration.

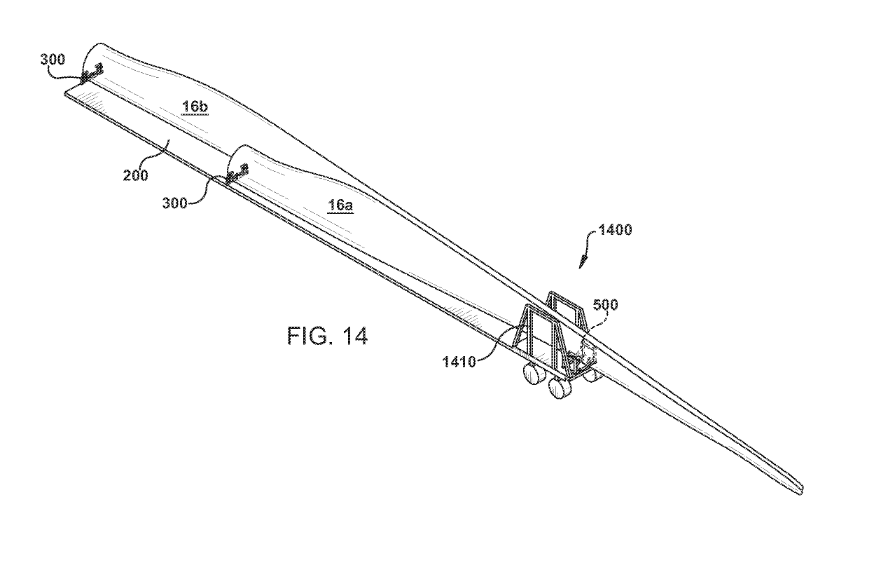

FIG. 14 illustrates a perspective view of a rotor blade fixture 1400 for transporting two rotor blades, according to an aspect of the present invention. The rotor blade fixture 1400 may be attached to supporting surface or trailer 200, and includes truss walls or frame 1410. The root fixtures 300 are attached to the root end of each rotor blade 16a, 16b. The mid-span supports 500 (i.e., the tip fixtures) may be mounted on the trailer 200 or on the rotor blade fixture 1400. The first root mounting fixture is separated from the second root mounting fixture in a span direction of the two rotor blades. The rotor blades may be viewed as being in a staggered arrangement, wherein the root of rotor blade 16b is located substantially forward of the root end of rotor blade 16a. This configuration reduces overall weight and reduces overall width due to the staggered blade configuration.

The rotor blade fixtures herein described demonstrate substantially improved results when shipping or transporting rotor blades, because two blades may be shipped with one vehicle. This cuts shipping/transportation costs in half for segments of the transport route. In addition, some locations limit the length of trailers, so the rotor blade fixtures enable longer rotor blades to be transported with trailers that would otherwise be too short. The results were unexpected because it was not anticipated that two long rotor blades could be shipped on a short trailer.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

1. A transportation system for transporting one or more rotor blades, the system comprising:
a rotor blade fixture configured to support one or more rotor blades, the rotor blade fixture having a first end and a second end opposed to the first end, the first end configured for mounting to a root end of a first rotor blade, the rotor blade fixture having at least one first mid-span support located between about 50% and 80% of a rotor blade span of the first rotor blade, the first mid-span support configured for supporting a mid-span portion of the first rotor blade, the rotor blade fixture configured to mount to a supporting surface so that a portion of the rotor blade fixture and the first rotor blade overhangs the supporting surface, the rotor blade fixture comprised of a truss framework, the truss framework configured to support the one or more rotor blades in the portion that overhangs the supporting surface; and
wherein the one or more rotor blades are supported at the root end and at a mid-span location located between about 50% and about 80% of the rotor blade span.

2. The system of claim 1, wherein the second end is configured for mounting to a root end of a second rotor blade, the rotor blade fixture having at least one second mid-span support located between about 50% and about 80% of a rotor blade span of the second rotor blade, the second mid-span support configured for supporting a mid-span portion of the second rotor blade.

3. The system of claim 1, wherein the supporting surface is a trailer, and the rotor blade fixture is configured so that a center of gravity of the fixture and the one or more rotor blades is located above a portion of the trailer.

4. The system of claim 1, wherein the rotor blade fixture is configured to be located substantially between two rotor blades.

5. The system of claim 4, the rotor blade fixture further comprising a platform configured for supporting and securing a mid-span support, the platform extending outside a width of the supporting surface.

6. The system of claim 1, wherein the rotor blade fixture is configured to be located substantially on a leading edge side and a trailing edge side of at least a portion of the one or more rotor blades.

7. The system of claim 1, the rotor blade fixture further comprising:
a removable top section configured to facilitate loading and unloading of the one or more rotor blades.

8. The system of claim 1, wherein the rotor blade fixture includes two truss walls and the one or more rotor blades are configured to be retained between the two truss walls.

9. The system of claim 1, wherein the one or more rotor blades are arranged in a staggered arrangement, wherein the root end of the first rotor blade is located substantially forward of a root end of a second rotor blade.

10. A transportation system for transporting one or more rotor blades, the system comprising:
a rotor blade fixture configured to support two rotor blades, the rotor blade fixture having a first end and a second end opposed to the first end, the first end configured for mounting to a root end of a first rotor blade, the second end configured for mounting to a root end of a second rotor blade, the rotor blade fixture having at least one first mid-span support configured for supporting a mid-span portion of each of the two rotor blades, the rotor blade fixture configured to mount to a supporting surface so that a portion of the rotor blade fixture and the two rotor blades overhang the supporting surface; and
wherein the rotor blade fixture comprises a truss framework configured to support the two rotor blades in the portion that overhangs the supporting surface, the truss framework extending from the root end to at least the mid-span portion.

11. The system of claim 10, wherein the supporting surface is a trailer, and the rotor blade fixture is configured so that a center of gravity of the fixture and the two rotor blades is located above a portion of the trailer.

12. The system of claim 11, wherein the rotor blade fixture is configured to be located substantially between the two rotor blades.

13. The system of claim 12, the rotor blade fixture further comprising:
a platform configured for supporting and securing the at least one first mid-span support, the platform extending outside a width of the supporting surface.

14. The system of claim 11, wherein the rotor blade fixture is configured to be located on at least a portion of a leading edge side and a trailing edge side of each of the two rotor blades; and
wherein the rotor blade fixture is configured to have a width equal to or less than a width of the trailer.

15. The system of claim 14, the rotor blade fixture further comprising:
a removable top section configured to facilitate loading and unloading of the two rotor blades.

16. The system of claim 11, wherein the truss framework includes two substantially parallel truss walls and the two rotor blades are configured to be retained between the truss walls.

17. The system of claim 11, wherein the one or more rotor blades are arranged in a staggered arrangement, wherein the root end of the first rotor blade is located substantially forward of the root end of the second rotor blade.

18. A transportation system for transporting one or more rotor blades, the system comprising:
a rotor blade fixture configured to support two rotor blades, the rotor blade fixture comprising a first root mounting fixture for mounting to a root end of a first rotor blade, and a second root mounting fixture for mounting to a root end of a second rotor blade, the first root mounting fixture separated from the second root mounting fixture in a span direction of the two rotor blades;
the rotor blade fixture configured to mount to a supporting surface, a portion of the rotor blade fixture overhangs the supporting surface;
the rotor blade fixture comprising a truss framework configured to support at least one of the two rotor blades in the portion that overhangs the supporting surface; and
wherein the root end of the second rotor blade is located substantially forward, in the span direction, of the root end of the first rotor blade.

19. The system of claim 18, wherein the supporting surface is a trailer, and the rotor blade fixture is configured so that a center of gravity of the fixture and the two rotor blades is located above a portion of the trailer.

20. The system of claim 19, wherein the rotor blade fixture is configured to have a width equal to or less than a width of the trailer.
